(19) United States
(12) Patent Application Publication
(10) Pub. No.: US 2003/0054564 A1
(43) Pub. Date: Mar. 20, 2003

(54) Method for sample preparation and storage for use with bioreaction chips

(76) Inventor: Scott L. Diamond, Bala Cynwyd, PA (US)

Correspondence Address: Barbara E. Johnson, WEBB ZIESENHEIM LOGSDON ORKIN & HANSON, P.C., 700 Koppers Building, 436 Seventh Avenue, Pittsburgh, PA, 15219-1818, US

(21) Appl. No.: 10/222,201

(22) Filed: Aug. 16, 2002

Related U.S. Application Data
(60) Provisional application No. 60/313,367, filed on Aug. 17, 2001.

(51) Int. Cl. G01N 1/00

(52) U.S. Cl. 436/174; 436/183

(57) ABSTRACT

A method is defined wherein a Master Library of individual compounds, mixtures of compounds, or reaction pre-mixtures in solvent are prepared for storage and subsequent utilization in a Distribution-Ready Library by delivery of the master stock constituents into a distribution formulation liquid (DFL). The individual compounds within the Master Library can include peptides, proteins, organic chemicals, pharmaceutical compounds, RNA, DNA, or cell fractions. The Distribution-Ready Library can be maintained indefinitely in storage. At the time of manufacture or time of need, the Distribution-Ready Library is microarrayed onto substrates at high density, thereby creating numerous Library Microarrays that are identical replicates of the Master Library compound(s) in DFL at fixed and known positions on the substrate. The DFL has a defined surface tension to maintain the Master Library compound in a non-spreading, non-beading adherent microdot, or spot, at a fixed position on the substrate in a manner that is stable for extended periods of time.

### CROSS REFERENCE TO RELATED APPLICATION

This patent application claims the benefit of U.S. Provisional Application Serial No. 60/313,367, filed Aug. 17, 2001, incorporated herein by reference.

### BACKGROUND OF THE INVENTION

1. Field of the Invention

The invention pertains to improvements in combinatorial chemistry methods as practiced in association with particular bioreaction chips (microarrays).

2. Description of Related Art

Libraries of chemical compounds can be created through solid or liquid phase synthesis techniques of combinatorial chemistry. Ronald Frank at the German National Research Center for Biotechnology (Braunschweig) was the first scientist to recognize the potential of combining several different solid-support-bound substrates for a reaction with a single reagent, Frank, R., et al., Nucleic Acids Res. Vol. 11, pp. 4365-4377 (1983). One or more solid-support-bound substrates can be combined together in any reaction vessel, with the individual substrates' being physically separated by covalent attachment to their respective carriers. In the work of Frank, paper disks were used as solid supports for the synthesis of oligonucleotides, wherein each disk contained only one nucleotide substrate used in the oligonucleotide polymerization.

Later on, Richard Houghten of the Scripps Research Institute in La Jolla, Calif. applied the method of combining different support-bound substrates to solid-phase peptide synthesis on resin beads. Each of the beads was about 100 micrometers in size, so each bead was too small by itself to yield the desired micromolar amounts of material, and Houghton, therefore, typically placed quantities of beads into meshed polypropylene packets resembling “tea-bags.” Each tea-bag could, in turn, be moved from reaction vessel to reaction vessel, where the successive addition of each amino acid to the growing polymer chain took place. This approach required multiple reaction vessels, and ultimate harvesting of the peptide thus grown from the individual bead supports, but provided for potential compound synthesis exponentially in excess of the number of reaction vessels. Different tea-bags undergoing different synthetic reactions (i.e., different protocols of exposure in various reaction vessels) were encoded such as with an alphanumeric code. As far as the compounds in the “library,” that is, the starting materials in the various reaction vessels, the operator was in complete control to include or exclude compounds of interest.

The concept of simplifying combinatorial chemistry protocols, such as described above, was further advanced using split-and-pool methods in order, in part, to reduce the number of reaction vessels needed. Random split-and-pool methods involved splitting a sample of solid supports into a given number of fractions, charging each subset to its own reaction vessel for reaction, collecting and thoroughly mixing the solid supports back together, with successive splitting, reacting, and remixing. Directed split-and-pool methods provided for the identification of the beads and their chemical history. Coding principals were introduced to determine the chemical structure of the synthesized compound attached to any given solid support, because the quantity generated was so small that the chemical structure could not be determined using classic methods. In some cases, simultaneous synthesis of a compound and a decodable nucleic acid were performed on the same solid support from the same reaction mixtures, with the nucleic acid thus providing a decodable tag identifying the sequential reactants which led to the second synthetic compound. Nucleic acid tags are hardly compatible with organic or otherwise incompatible reaction systems, so other encoding techniques are also in development. Whether simple or directed split-and-pool or other combinatorial chemistry methods, however, the main thrust of this technology has been the progression of the scientific community's interest in it, beginning with the initial enormous, macroscopic operations where initial efforts began to the laboratory facilities of individual medicinal and other chemists today.

Even when libraries of compounds of interest have already been created, simplicity in handling and evaluating those libraries is still a contemporary goal. Libraries of chemical compounds, created via techniques of combinatorial chemistry, can and often do include 100 to 1,000,000 or more individual constituents, either as individual compounds in individual tubes (or wells of a multi-well plate) or as sub-library mixtures resident in individual tubes (or wells of a multi-well plate). When multi-well plates are used, typically the compounds reside in 96-, 384-, or 1536-well plates, with each well containing the compound of interest in an appropriate solvent or carrier. Non-biological libraries of compounds are often present in wells containing a volume of 10-250 microliters of an organic solvent, such as DMSO, ethanol, or methanol. Standard utilization of such combinatorial libraries involves the robotic transfer of a volume (0.1 to 250 microliters) from each well of the library into a reaction well where an assay is conducted in the presence of the chemical compound(s) from the library, in a process termed “high-throughput screening.” Currently, only a handful of tests are possible before the constituents of the library are consumed in screening reactions. It would, therefore, be extremely useful in the combinatorial chemistry and high-throughput screening arts to have a technique whereby 100s, 1000s, or 10,000s of assay tests could be conducted with each member constituent of a Master library.

### SUMMARY OF THE INVENTION

A method is defined whereby a Master Library of individual compounds, mixtures of compounds, or reaction pre-mixtures in solvent are prepared for storage and subsequent utilization in a Distribution-Ready Library by admixture of the master stock constituents with a distribution formulation liquid (DFL). The individual compounds within the Master Library can include peptides, proteins, organic chemicals, pharmaceutical compounds, RNA, DNA, or cell fractions. The Distribution-Ready Library can be maintained indefinitely in storage. At the time of manufacture or time of need, the Distribution-Ready Library is microarrayed onto substrates at high density, thereby creating numerous Library Microarrays that are identical replicates of the Master Library compound(s) in DFL at fixed and known positions on the substrate. The DFL has a defined surface tension to maintain the Master Library compound in a non-spreading, non-beading adherent spot at a fixed position on the substrate in a manner that is stable for extended periods of time. The DFL may contain a volatile component that evaporates after microarraying so as to reduce the adherent spot size. Chemical linkage of the compounds, mixtures of compounds, or reaction pre-mixtures to the slide is not required. The library microarrays are suitable for the conducting of chemical and biochemical reactions, exposure to electromagnetic radiation, or exposure to living cells or cell fractions.

### BRIEF DESCRIPTION OF THE DRAWING(S)

FIG. 1 is a schematic diagram showing the interrelationships of the Master Library, the distribution formulation liquid (DFL), the Distribution-Ready Library (which results when the Master Library and DFL are admixed), and the utility of Microarrayed Library(ies) created therefrom.

### DESCRIPTION OF THE PREFERRED EMBODIMENT(S)

As described above, a Master Library of individual compounds, mixtures of compounds, or reaction pre-mixtures in solvent are prepared for storage and subsequent utilization in a “distribution-ready” library by delivery of the master stock constituents into a distribution formulation liquid (DFL). The individual compounds within the Master Library can include peptides, proteins, organic chemicals, pharmaceutical compounds, RNA, DNA, or cell fractions. The Distribution-Ready Library can be maintained indefinitely in storage by virtue of the characteristics of the DFL. At the time of manufacture or time of need, the Distribution-Ready Library is microarrayed onto substrates at high density, thereby creating numerous Library Microarrays that are identical replicates of the Master Library compound(s) in DFL at fixed and known positions on the substrate. The DFL has a defined surface tension to maintain the Master Library compound in a non-spreading, non-beading adherent spot at a fixed position on the substrate in a manner that is stable for extended periods of time. The DFL may contain a volatile component that evaporates after microarraying so as to reduce the adherent spot size. Chemical linkage of the compounds, mixtures of compounds, or reaction pre-mixtures to the slide is not required. The library microarrays are suitable for the conducting of chemical and biochemical reactions, exposure to electromagnetic radiation, or exposure to living cells or cell fractions.

More particularly, the present invention is a method in which a Master Library of individual master compound or individual master mixtures of compounds in solvent are prepared for use or storage. The individual compounds within the Master Library can include: peptides, proteins, organic chemicals, pharmaceutical compounds, RNA, DNA, or cell fractions, among others. A Master Library can be defined as a collection of small organic molecule libraries (MW<5,000), double-stranded or single-stranded DNA libraries, RNA libraries, protein libraries, protein subdomain libraries, fluorogenic substrate libraries, cell lysate, cell fractions, whole cell libraries, or tissue libraries; or predefined mixtures or combinatorial mixtures of members of a sub-library.

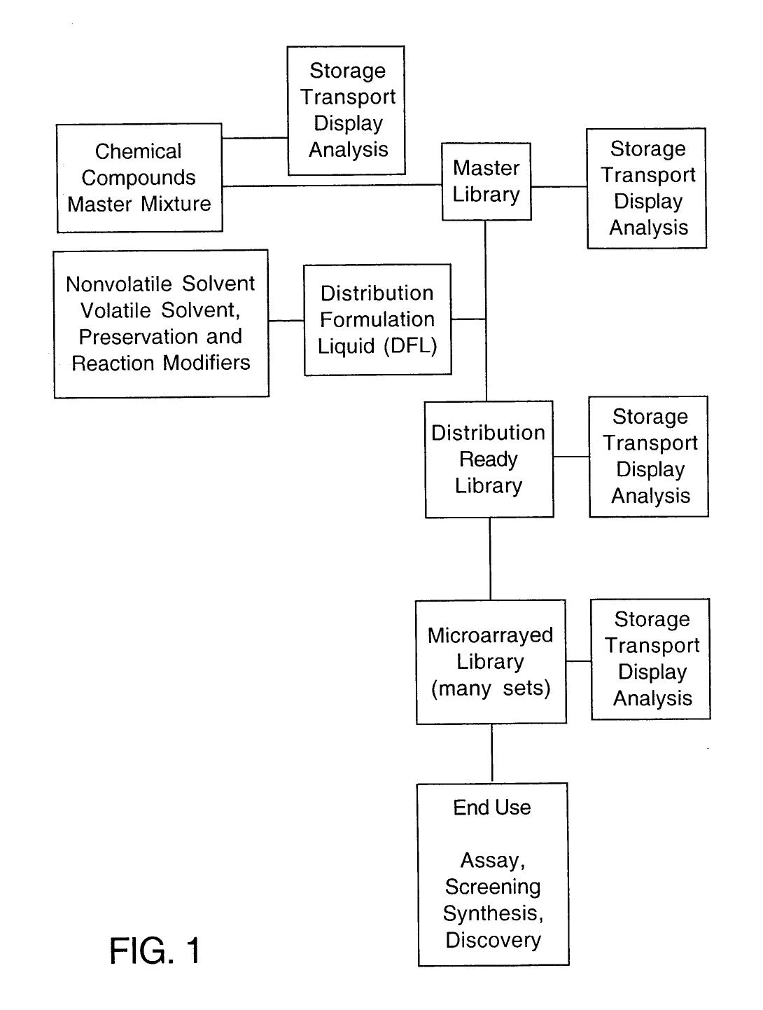

Various examples of sample compositions of a Master Mixture (as shown in FIG. 1) may include, without limitation: a fluorogenic peptide substrate in dimethylsulfoxide (DMSO); a fluorogenic peptide substrate with an enzyme inhibitor in DMSO; an enzyme inhibitor in DMSO; a fluorogenic peptide substrate, an enzyme inhibitor, an ionic salt, a buffering agent, an antioxidant, an antibody, and a microcarrier bead with attached chemical constituents, maintained in a solvent such as DMSO, methanol, glycerol or water; a dissolved pharmaceutical compound in DMSO; a quenched fluorogenic phosphorylated peptide, ATP, a phosphatase inhibitor, or a protease enzyme, maintained in a solvent such as DMSO, methanol, glycerol or water; a sequence of DNA containing an RNA polymerase binding site, GTP, ATP, UTP, CTP, and magnesium in glycerol and water; a dissolved mixture of pharmaceutical compounds containing chemical heterogeneity at a specific R-group of the molecule; a dissolved mixture of pharmaceutical compounds, peptides, antibodies, and fluorogenic substrates maintained in a solvent such as DMSO, methanol, glycerol, or water.

Although the mixture may be maintained at a 1×to 1000×concentration of constituents in preparation for defined dilutional events, typically the master mixture is ultimately diluted to a 1×concentration at the time of final utilization. For example, a Master Mixture can contain a 100 millimolar concentration of a fluorogenic peptide in DMSO that is diluted 10×to 10 millimolar upon formation of the Distribution-Ready Library and diluted further 10×to 1 millimolar upon usage in a final assay reaction where the desired final concentration of the fluorogenic peptide is 1 millimolar.

A key feature of the invention is the “DFL,” the distribution formulation liquid, which has a defined composition to maintain the constituents of the Master Library in a stable form for long term storage. The DFL has a defined composition so as to display a surface tension to maintain the Master Library compound in a non-spreading, non-beading adherent droplet at a fixed position on a particular substrate of choice in a manner that is stable for extended periods of time after arraying. DFL is usually, if not always: miscible with water; miscible with common organic solvents such as DMSO, ethanol, methanol, etc.; moderately viscous, with a viscosity between 1-10,000 Centipoise; compatible with biological molecules and biological reagents such as nucleic acid, peptides, proteins, sugars, or small 20 nanomolar to 200 nanomolar microcarrier beads; adequately fluid for movement into and out of microcapillary devices such as hollow tips, microarray pins, or microsyringes used for arraying; able to create a specific contact angle to form a stable finite lens where the bioreaction fluid in the spot after arraying does not spread (contact angle >0) but wherein the stable adherent lens thus formed does not have too low of adhesion that the spot can roll on the substrate (contact angle <90); and low enough in volatility of one component such that the reaction zone does not completely evaporate. Although the DFL may contain a volatile component (the volatile solvent) and a non-volatile component (termed the carrier solvent) that is suitable for applying small volumes of a fluid mixture to a surface by microarraying or positive displacement whereby evaporation of the volatile solvent results in highly localized, long-lasting liquid microdot residue of master mixture components in a solution of carrier solvent where the volatile solvent in the DFL is suitable for obtaining a true solution of fluorogenic or chromogenic substrate at high concentration. This solvent may be DMSO, chloroform, acetone, 5% acetic acid, water, an alcohol such as methanol, ethanol or propanol, ethyl ether, or alkane.

Using the above described DFL, the Distribution-Ready Library is constructed with the requirement of preserving the library indefinitely in storage and maintaining a suitable environment for subsequent microarraying manipulations. The individual members of the Master Library are added to wells that are preloaded with the DFL. For example, a fixed volume of liquid (1 to 50 microliters) may be removed from the Master Library well and charged to a multi-well plate well containing 10 to 200 microliters of the DFL to yield the Distribution-Ready Library. The Distribution-Ready Library can be utilized for microarraying, stored at room temperature or at refrigerated temperatures (4° C.) or frozen at (0° C., −20° C. or −80° C.). The Distribution-Ready Library can likewise be maintained in multi-well plates including, but not limited to, 96-well, 384-well and 1536-well plates. Due to the composition of the DFL, the Distribution-Ready Library is well-suited for long-term storage and stability under any of the above circumstances.

Additional features of the DFL, which are central to the present invention, are as follows. The DFL may contain a carrier solvent which is of low volatility, miscible with any volatile solvent, or miscible with water-containing biological fluids. The DFL is in many cases suitable for maintaining a true solution of fluorogenic or chromogenic substrate at high concentration after evaporation of the volatile solvent. The carrier solvent may be a polyalcohol, such as 1,2-ethanediol, 2,3-butanediol, or 1,2,3-propanetriol (glycerol). The carrier solvent of the DFL may contain viscosity enhancers such as dextran, pluronic acid, carbohydrates of the pentose, ribose or hexose families and related polysaccharides; or polyethylene glycol polymers. The carrier solvent of the DFL may contain biological molecules or biological fractions, such as peptides, proteins, enzymes, antibodies, membrane lipid, cell lysates, vesicles, or liposomes; or small diameter solid or porous beads containing immobilized thereon by covalent or non-covalent means any molecular or macromolecular entities such as antibodies, proteins, enzymes, peptides, covalently attached lipids, or other organic functional groups. The carrier solvent may include fluorogenic substrates, chromogenic substrates, enzyme co-factors, inhibitors, or activators. Volatile solvent facilitates fluid handling and delivery by reduction of formulation viscosity. Evaporation of the volatile solvent facilitates additional concentrating of non-volatile reactive components. The non-volatile carrier solvent and its constituents represent a high viscosity fluid with significant yield stress and surface tension to resist fluid motion. The non-volatile carrier solvent and its constituents allow for the maintaining of the fluorogenic or chromogenic substrate and co-factors and inhibitors or activators or other biological additives to remain in the liquid state without crystallization or precipitation. The DFL may contain buffering agents, chelating agents, an antioxidant, a reducing agent such as beta-mercaptoethanol, or antimicrobial agents as preservatives.

Sample formulas for the DFL are provided as follows, with any of the following being very typical DFL formulations: 50% glycerol, 10% DMSO, and 40% water; 80% glycerol, 10% DMSO, and 10% water; 50% ethylene glycol, 10% DMSO, and 40% water; 90% glycerol, and 10% water; and 90% glycerol and 10% DMSO.

At the time of manufacture or at the time of need, the Distribution-Ready Library is microarrayed onto substrates at high density, thereby creating numerous Library Microarrays or individual Microarrayed Library sets that are identical replicates of the Master Library compound(s) in DFL and are resident in the DFL at fixed and known positions on the substrate. The volatile constituents of the DFL can evaporate rapidly due to the high surface area to volume ratio of each spot on the microarray.

Chemical linkage of the compounds, mixtures of compounds, or reaction pre-mixtures to the solid substrate forming the base of the microarray is not required. The Library Microarrays are suitable for the conduct of chemical and biochemical reactions, exposure to electromagnetic radiation, or exposure to living cells or cell fractions.

Chemical linkage of the compounds, some or all of the compounds of the mixtures of compound originally present in the Distribution-Ready Library well can be achieved by use of substrates pre-activated with linkage chemistries prior to arraying the Distribution-Ready Library.

The final volume of the microdot, or spot, on the microarray, after evaporation of any volatile solvent, can range from about 1 to 50 nanoliters. These spots can be applied through fluid handling methods of: direct positive displacement pumping; microarraying whereby computer-controlled metal or plastic tips (pins) pick up droplets of fluid from a reservoir by capillary action and make contact with the solid surface; or jet printing techniques. Separation distances between microdot edges is set at 10 to 1000 micrometers. Surfaces for delivery of liquid from the Distribution-Ready Library include silicon, glass, silica, quartz, polystyrene, nylon membranes, or other porous or non-porous polymeric membranes. Sets of 100 replicates may be microarrayed from each pin sampling of the Distribution-Ready Library with each well being sampled by the pin of the microarrayer at least 1000 times per 100 microliters of volume of the Distribution-Ready Library. Not all the Distribution-Ready Library need be used at one time, and it can be returned repeatedly to short- or long-term storage as need dictates.

Microarrayed Library sets may be used for drug screening; drug-drug interaction testing; or for biomaterial, bioformulation, biodistribution; or bioreaction measurement or discovery. Multiple sets of the Microarrayed Library may be thus utilized as replicates for replicate determinations in drug screening; drug-drug interaction studies; biomaterial, bioformulation, biodistribution; or bioreaction measurement or discovery to enhance the statistical reliability of any such tests or determinations. Multiples of the Microarrayed Library sets, containing 100 to over 1 million spots in the aggregate, can be used for high-throughput screening, as one example for drug discovery of molecules that bind a protein target, a lipid target, an organic molecule target, or inhibit a biological reaction or biological process.

The invention claimed is:

1. A method for creating a storable Distribution-Ready Library, comprising formulating a distribution formulation liquid and admixing thereto a sample of material from a Master Library, said Master Library comprising at least one chemical compound, wherein said storable Distribution-Ready Library thus formed is characterized by its ability to form microarrays in which the spots formed therefrom are non-spreading, non-beading and stable for an extended period of time.

2. A method for making and using a storable Distribution-Ready Library, comprising formulating a distribution formulation liquid and admixing thereto a sample of material from a Master Library, said Master Library comprising at least one chemical compound, to form a Distribution-Ready Library; and using said Distribution-Ready Library to create microarrays of individual spots of the Distribution-Ready Library on a solid substrate.

3. The method according to claim 2, wherein the Master Library contains compounds selected from the group consisting of peptides, proteins, organic chemicals, pharmaceutical compounds, RNA, DNA, and cell fractions.

4. The method according to claim 2, wherein the distribution formulation liquid has a defined surface tension to maintain the Master Library compound in a non-spreading, non-beading adherent spot at a fixed position on the microarray in a manner that is stable for extended periods of time.

5. The method according to claim 4, wherein the distribution formulation liquid contains at least one constituent selected from the group consisting of glycerol, ethylene glycol, dimethylsulfoxide and water.

6. The method according to claim 4, wherein the distribution formulation liquid contains at least one volatile component.

7. The method according to claim 6, wherein the distribution formulation liquid further is miscible with water and has a viscosity between 1-10,000 Centipoise.

8. The method according to claim 7, wherein the distribution formulation liquid further contains at least one compound selected from the group consisting of polyalcohol, viscosity enhancer, saccharide, and polyalkylene glycol polymer.

9. A microarray comprising a solid substrate, and a plurality of spots on said substrate comprising an admixture of a Master Library and a distribution formulation liquid, wherein the distribution formulation liquid has a surface tension adequate to maintain the spots in a non-spreading, non-beading configuration, and further wherein no chemical constituent of the Master Library is covalently linked or otherwise chemically bonded to the substrate except by the adherence created by the distribution formulation liquid.

10. The microarray according to claim 9, wherein said distribution formulation liquid contains at least one compound selected from the group consisting of glycerol, ethylene glycol, dimethylsulfoxide and water and wherein said microarray is suitable for discovery or measurement processes and subsequent reactions when one or more agents are contacted onto the microarray.
